(19) United States
(12) Patent Application Publication
(10) Pub. No.: US 2025/0368090 A1
(43) Pub. Date: Dec. 4, 2025

(54) BATTERY EXCHANGE STATION AND METHODS OF EXCHANGING A RECHARGEABLE BATTERY AT A BATTERY EXCHANGE STATION

(71) Applicant: Ocado Innovation Limited, Hatfield (GB)

(72) Inventor: Christopher STAREY, Hatfield (GB)

(21) Appl. No.: 19/299,242

(22) Filed: Aug. 13, 2025

Related U.S. Application Data
(63) Continuation of application No. PCT/EP2024/053713, filed on Feb. 14, 2024.

(30) Foreign Application Priority Data
Feb. 14, 2023 (GB) 2302084.5

(51) Int. Cl. B60L 53/80; H01M 10/42; H01M 10/44; H01M 10/48; H01M 50/244

(52) U.S. Cl. CPC B60L 53/80; H01M 10/425; H01M 10/441; H01M 10/443; H01M 10/482; H01M 10/486; H01M 10/488; H01M 50/244; H01M 2010/4271; H01M 2010/4278

(57) ABSTRACT

A battery exchange station is provided for charging a plurality of batteries, each of the plurality of batteries including a battery management system (BMS), the battery exchange station including: i) a cabinet comprising a plurality of battery chargers; ii) a plurality of bays each configured to receive a battery, the plurality of bays comprising: a) a plurality of charging bays, each including an electrical connector for connecting to the battery received in the charging bay, each electrical connector being electrically coupled to a respective one of the plurality of battery chargers; b) one or more non-charging buffer bays, each including coupling means configured to establish communication with the BMS of the battery received in the non-charging buffer bay; and iii) a robotic arm configured to exchange a battery located in a battery-powered device with a battery located in one of the plurality of charging bays.

### TECHNICAL FIELD

The present disclosure relates to a battery exchange station, and to methods of performing a battery exchange at a battery exchange station.

### BACKGROUND

Some commercial and industrial activities require systems that enable the storage and retrieval of a large number of different products. WO2015019055A1 describes a storage and retrieval system in which stacks of storage containers are arranged within a grid storage structure. The system further comprises remotely operated load handling devices configured to move on tracks located on the top of the grid storage structure. To access the containers in the grid storage structure, the load handling devices are equipped with a container-holding device for releasably gripping a container at the top of a stack and a lifting mechanism for raising and lowering the container.

Each load handling device is powered by a rechargeable battery. The rechargeable battery is typically charged in situ by driving a load handling device to a charging station located at the edge of the grid storage structure. The load handling device remains stationary at the charging station while the battery is recharged. The charging period is a significant source of downtime for the load handling device and can be on the order of hours.

To alleviate the problem of charging downtime, the load handling device may be powered by an exchangeable battery. When the battery in the load handling device is depleted, the depleted battery is exchanged for a fully charged battery and therefore the charging downtime is reduced to the time it takes to exchange the battery, rather than being the time to charge the battery.

The present disclosure aims to provide improvements to battery exchange systems.

### SUMMARY

The disclosure is defined in the accompanying claims.

A battery exchange station is provided for charging a plurality of batteries, each of the plurality of batteries comprising a battery management system (BMS), the battery exchange station comprising:
i) a cabinet comprising a plurality of battery chargers;
ii) a plurality of bays each configured to receive a battery, the plurality of bays being grouped into:
   a) a first sub-group of bays, the first sub-group comprising a plurality of charging bays, each of the plurality of charging bays comprising an electrical connector for connecting to the battery received in the charging bay, each electrical connector being electrically coupled to a respective one of the plurality of battery chargers;
   b) a second sub-group of bays, the second sub-group comprising one or more non-charging buffer bays, each of the one or more non-charging buffer bays comprising coupling means configured to establish communication with the BMS of the battery received in the non-charging buffer bay; and
iii) a robotic arm configured to exchange a battery located in a battery-powered device with a battery located in one of the plurality of charging bays.

Non-charging buffer bays may be referred to as buffer bays, and the two terms are used interchangeably. Each buffer bay may not be configured to charge a battery received in the buffer bay. In other words, each buffer bay is not a charging bay. For example, each buffer bay may not be electrically coupled to a battery charger. For example, each buffer bay may not comprise an electrical connector for connecting to a corresponding electrical connector of a battery.

The cabinet may be a single body. The plurality of bays may be housed in the cabinet. This has the advantage that the cabinet is easy to manufacture, and both the first sub-group and the second sub-group of bays are housed in the same cabinet.

Each of the plurality of bays may be in the form of a receptacle with an opening in a top surface of the cabinet to allow a battery to be received into the receptacle in a vertical direction. The cabinet may have a single top surface, with all of the bays having their openings in the top surface.

The cabinet may comprise a first top surface and a second top surface, and the respective opening of each of the plurality of charging bays in the first sub-group may be in the first top surface, and the respective opening of each of the one or more non-charging buffer bays in the second sub-group may be in the second top surface. The second top surface of the cabinet may be at a lower vertical level than first top surface of the cabinet. This may be useful if the buffer bays need to be at a height that is more convenient for a human worker to access.

The ratio of the number of charging bays in the first sub-group to the number of non-charging buffer bays in the second sub-group may between 2:1 and 10:1. The ratio of the number of charging bays in the first sub-group to the number of non-charging buffer bays in the second sub-group is 4:1. In some examples, the second sub-group consists of a single non-charging buffer bay. In other examples, the second sub-group comprises a plurality of non-charging buffer bays. This has the advantage of providing redundancy in the case that one of the non-charging buffer bays is not operational.

One or more of the plurality of bays may comprise one or more sensors to detect the presence of a battery in the bay.

One or more of the plurality of bays may further comprise a visual indicator of the state of charge of a battery received within the bay. For example, an LED located next to the bay may indicate whether a battery in the bay is fully charged. In some examples, LEDs of different colours may be used to indicate different levels of state of charge, for example green for >80% SOC, yellow for 50-80% SOC, red for <50% SOC. In some examples, a visual indicator (for example, an LED) may indicate whether a battery in the bay is in an error state (for example, the BMS has an error code, or the temperature of the battery is outside a predetermined range.

In some examples, the battery exchange station may send a wireless signal to a mobile device with information about a battery in a bay, for example the SOC or temperature or error state.

The battery exchange station may further comprise a control system configured to:
i) determine the state of charge of a battery received within one of the plurality of non-charging buffer bays; and
ii) instruct the robotic arm to move the battery from the non-charging buffer bay to one of the plurality of charging bays if the state of charge of the battery is below a predetermined threshold charge level.

The control system may be a central control system for a storage and retrieval system, or a separate control system for the battery exchange station. Step ii) may be carried out by a local arm controller, instructed by the control system. The control system may comprise one or more processors and memory storing instructions, that when executed by the one or more processors, instruct the robotic arm to move the battery.

The control system may be further configured to:
i) determine whether the temperature of a battery in any of the plurality of bays exceeds a predetermined temperature threshold and/or whether the current of a battery in any of the plurality of bays exceeds a predetermined current; and
ii) activate a switch to disconnect the plurality of battery chargers from the plurality of charging bays if the temperature of the battery exceeds a predetermined temperature threshold and/or the current of the battery exceeds a predetermined current.

The switch may be a circuit breaker, fuse, or any other switch capable of cutting off the power supply to the charging bays.

A storage and retrieval system is provided, comprising:
a storage structure, the storage structure comprising:
   a plurality of horizontal members arranged to form a grid pattern defining a plurality of grid cells;
   a plurality of upright members configured to support the horizontal members from below to define a storage area below the grid cells for storing stacks of storage containers;
   a track structure located on top of the horizontal members, wherein the track structure comprises a plurality of tracks arranged to form a grid pattern corresponding to the grid pattern formed by the horizontal members; and
one or more load handling devices, each load handling device comprising:
   a driving assembly configured to move the load handling device on the track structure;
   a container-holding assembly configured to releasably hold a storage container from above; and
   a lifting assembly configured to raise and lower the container-holding assembly to allow the load handling device to lift and lower storage containers into and out of the storage structure and the passage via the grid cells;
one or more battery exchange stations as defined above, wherein each battery exchange station is located next to or on the track structure.

A method of exchanging a first battery with a second battery is provided, wherein the first battery is located in a battery-powered device and the second battery is located in a charging bay configured to charge a battery, the method comprising the steps of:
(i) removing the first battery from the battery-powered device and placing it in a non-charging buffer bay;
(ii) removing the second battery from the charging bay and placing it in the battery-powered device; and
(iii) removing the first battery from the non-charging buffer bay and placing it in the charging bay.

A method of exchanging a first battery with a second battery is provided, wherein the first battery is located in a battery-powered device and the second battery is located in a charging bay configured to charge a battery, the method comprising the steps of:
(i) removing the second battery from the charging bay and placing it in a non-charging buffer bay;
(ii) removing the first battery from the battery-powered device and placing it in the charging bay; and
(iii) removing the second battery from the non-charging buffer bay and placing it in the battery-powered device.

In either of the above methods, steps (i)-(iii) may be carried out by a robotic arm. All of the steps (i)-(iii) may be carried out by the same robotic arm.

### BRIEF DESCRIPTION OF THE DRAWINGS

The present disclosure will now be described, by way of example only, with reference to the accompanying drawings, in which:

FIG. 1 is a schematic perspective view of a storage structure and containers arranged within the storage structure.

FIG. 2 is a schematic plan view of a track structure on top of the storage structure of FIG. 1.

FIG. 3 shows load handling devices on top of the track structure of the storage structure of FIG. 1.

FIG. 4 is a schematic perspective view of a load handling device with a container-holding device in a position below the bottom of the load handling device.

FIG. 5 is a schematic perspective view of the load handling device of FIG. 4 with a side portion of the external body omitted from view to show a container-receiving space.

FIG. 6 is a schematic perspective view of the load handling device of FIG. 5 with a container occupying the container-receiving space.

FIG. 7A is a schematic perspective view of the load handling device with a battery received in a battery compartment.

FIG. 7B is a schematic cross-section view of the battery within the battery compartment.

FIG. 8 is a schematic perspective view of a battery exchange station comprising a cabinet with a side panel omitted from view.

FIG. 9 is a schematic perspective view of the battery exchange station next to the track structure of the storage structure.

FIGS. 10A, 10B, 10C, and 10D are top down views of the load handling device and the battery exchange station showing the steps of a method of exchanging a battery.

FIGS. 11A, 11B, 11C, and 11D are top down views of the load handling device and the battery exchange station showing the steps of another method of exchanging a battery.

### DETAILED DESCRIPTION

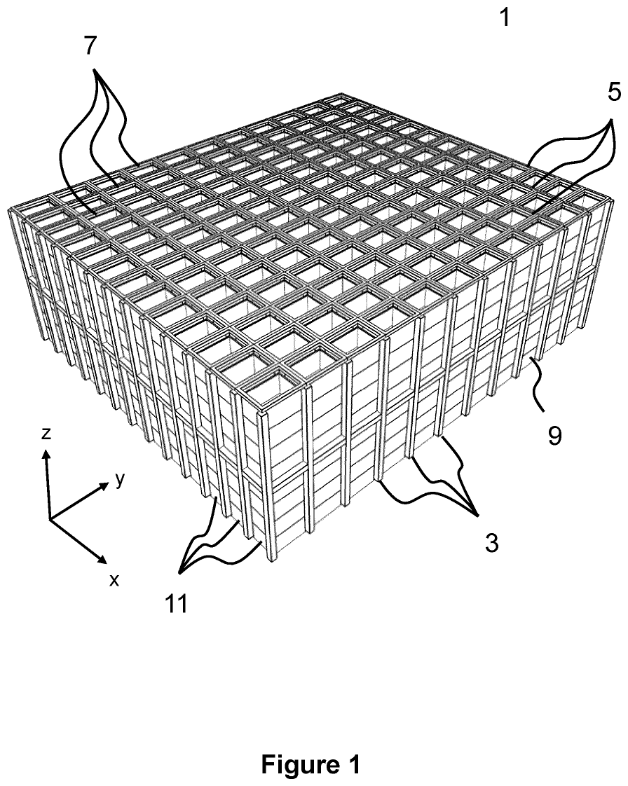

FIG. 1 shows an example storage structure 1 that may be used in a storage and retrieval system to store storage containers 9. The storage structure 1 comprises a framework comprising upright members 3 and horizontal members 5, 7 which are supported by the upright members 3. The horizontal members 5 extend parallel to one another and the illustrated x-axis. The horizontal members 7 extend parallel to one another and the illustrated y-axis, and transversely to the horizontal members 5. The upright members 3 extend parallel to one another and the illustrated z-axis, and transversely to the horizontal members 5, 7. The horizontal members 5, 7 form a grid pattern defining a plurality of grid cells 14. In the illustrated example, storage containers 9 are arranged in stacks 11 beneath the grid cells 14 defined by the grid pattern, one stack 11 of storage containers 9 per grid cell 14.

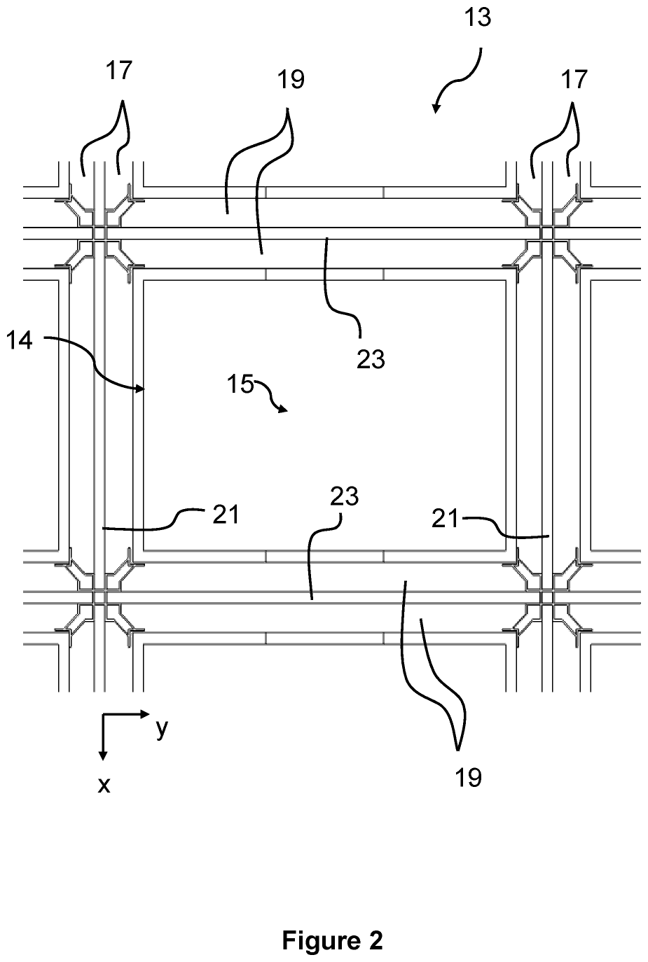

FIG. 2 shows a large-scale plan view of a section of track structure 13 forming part of the storage structure 1 illustrated in FIG. 1 and located on top of the horizontal members 5, 7 of the storage structure 1 illustrated in FIG. 18. The track structure 13 may be provided by the horizontal members 5, 7 themselves (e.g. formed in or on the surfaces of the horizontal members 5, 7) or by one or more additional components mounted on top of the horizontal members 5, 7. The illustrated track structure 13 comprises x-direction tracks 17 and y-direction tracks 19, i.e. a first set of tracks 17 which extend in the x-direction and a second set of tracks 19 which extend in the y-direction, transverse to the tracks 17 in the first set of tracks 17. The tracks 17, 19 define apertures 15 at the centres of the grid cells 14. The apertures 15 are sized to allow storage containers 9 located beneath the grid cells 14 to be lifted and lowered through the apertures 15. The x-direction tracks 17 are provided in pairs separated by channels 21, and the y-direction tracks 19 are provided in pairs separated by channels 23. Other arrangements of track structure may also be possible.

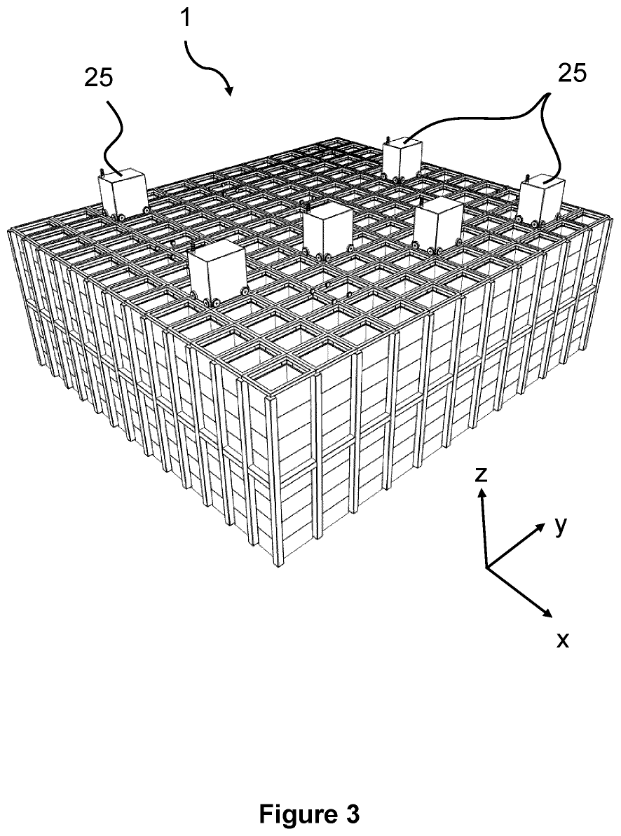

FIG. 3 shows a plurality of load handling devices 25 moving on top of the storage structure 1 illustrated in FIG. 18. The load handling devices 25, hereinafter referred to as “bots”, are provided with sets of wheels to engage with corresponding x- or y-direction tracks 17, 19 to enable the bots 25 to travel across the track structure 13 and reach specific grid cells 14. The illustrated pairs of tracks 17, 19 separated by channels 21, 23 allow bots 25 to occupy (or pass one another on) neighbouring grid cells 14 without colliding with one another.

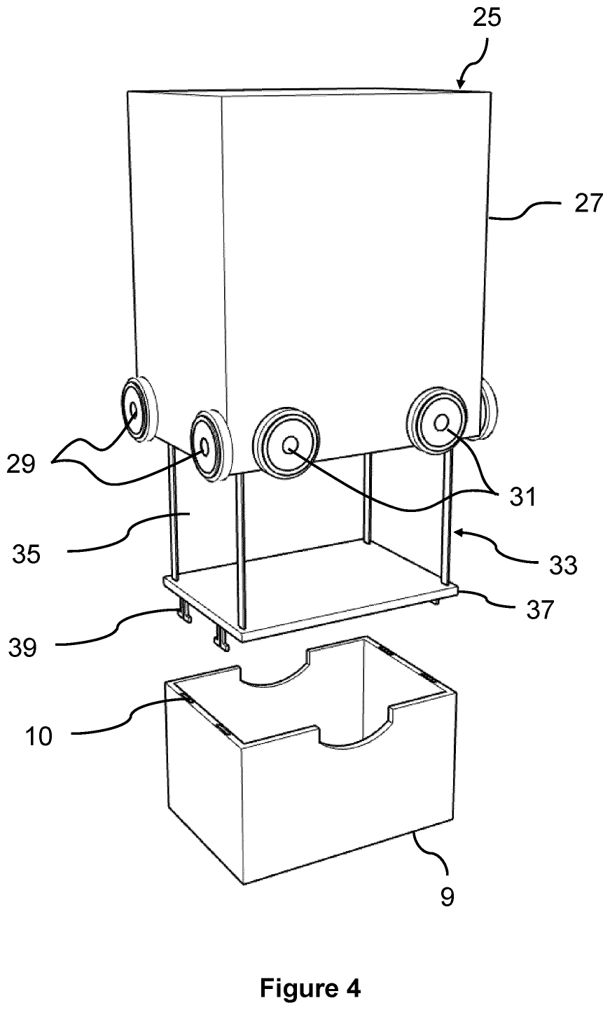

As illustrated in FIG. 4, a bot 25 comprises an external body 27 in or on which are mounted one or more components which enable the bot 25 to perform its intended functions. These functions may include moving across the storage structure 1 on the track structure 13 and raising or lowering storage containers 9 (e.g. from or to stacks 11) so that the bot 25 can retrieve or deposit storage containers 9 in specific locations defined by the grid pattern.

The illustrated bot 25 comprises a driving assembly comprising first and second sets of wheels 29, 31 which are mounted on the external body 27 of the bot 25 and enable the bot 25 to move in the x- and y-directions along the tracks 17 and 19, respectively. In particular, two wheels 29 are provided on the shorter side of the bot 25 visible in FIG. 4, and a further two wheels 29 are provided on the opposite shorter side of the bot 25. The wheels 29 engage with tracks 17 and are rotatably mounted on the external body 27 of the bot 25 to allow the bot 25 to move along the tracks 17. Analogously, two wheels 31 are provided on the longer side of the bot 25 visible in FIG. 4, and a further two wheels 31 are provided on the opposite longer side of the bot 25. The wheels 31 engage with tracks 19 and are rotatably mounted on the external body 27 of the bot 25 to allow the bot 25 to move along the tracks 19.

To enable the bot 25 to move on the different wheels 29, 31 in the first and second directions, the driving assembly further comprises a wheel-positioning mechanism (not shown) for selectively engaging either the first set of wheels 29 with the first set of tracks 17 or the second set of wheels 31 with the second set of tracks 19. The wheel-positioning mechanism is configured to raise and lower the first set of wheels 29 and/or the second set of wheels 31 relative to the external body 27, thereby enabling the load handling device 25 to selectively move in either the first direction or the second direction across the tracks 17, 19 of the storage structure 1.

The wheel-positioning mechanism may include one or more linear actuators, rotary components or other means for raising and lowering at least one set of wheels 29, 31 relative to the external body 27 of the bot 25 to bring the at least one set of wheels 29, 31 out of and into contact with the tracks 17, 19. In some examples, only one set of wheels is configured to be raised and lowered, and the act of lowering the one set of wheels may effectively lift the other set of wheels clear of the corresponding tracks while the act of raising the one set of wheels may effectively lower the other set of wheels into contact with the corresponding tracks. In other examples, both sets of wheels may be raised and lowered, advantageously meaning that the external body 27 of the bot 25 stays substantially at the same height and therefore the weight of the external body 27 and the components mounted thereon does not need to be lifted and lowered by the wheel-positioning mechanism.

The bot 25 also comprises a lifting assembly 33 and a container-holding assembly 37 configured to raise and lower storage containers 9. The illustrated lifting assembly 33 comprises four tethers 35 which are connected at their lower ends to the container-holding assembly 37. The tethers 35 may be in the form of cables, ropes, tapes, or any other form of tether with the necessary physical properties to lift the storage containers 9. The container-holding assembly 37 comprises a gripping mechanism 39 configured to engage with features of the storage containers 9 to releasably hold the containers 9 from above. In the illustrated example, the gripping mechanism 39 comprises legs that can be received in corresponding apertures 10 in the rim of the storage container 9 and then moved outwards to engage with the underside of the rim of the storage container 9. The tethers 35 can be wound up or down to raise or lower the container-holding assembly 37 as required. One or more motors and winches or other means may be provided to effect or control the winding up or down of the tethers 35.

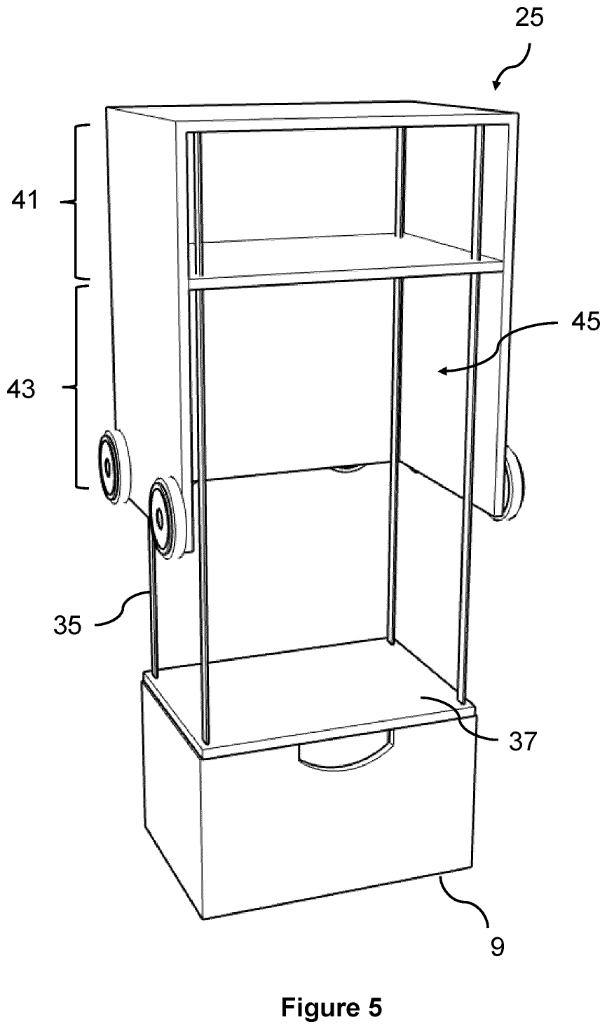

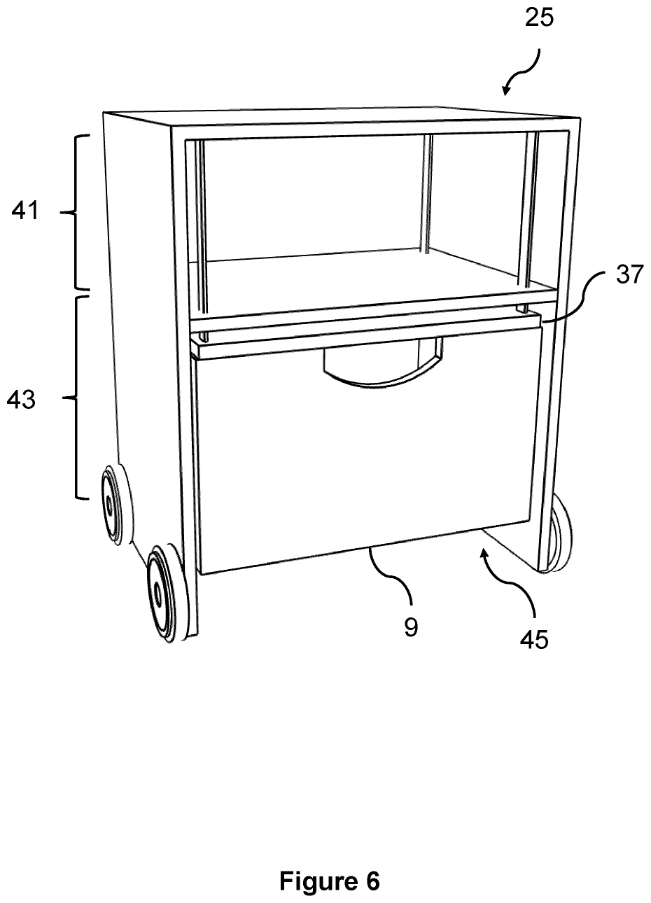

In FIG. 5 and FIG. 6, a side portion of the external body 27 of the bot 25 has been omitted from view to allow the interior of the bot 25 to be seen. The external body 27 of the illustrated bot 25 has an upper portion 41 and a lower portion 43. The upper portion 41 is configured to house or support one or more operation components (not shown), such as components of the lifting assembly 33 (e.g. motors), wireless communication components, one or more processors for controlling operation of the bot 25, etc. The lower portion 43 is arranged beneath the upper portion 41. The lower portion 43 is externally open at the bottom and defines a container-receiving space 45 for accommodating at least part of a storage container 9 that has been raised into the container-receiving space 45 by the lifting assembly 33. FIG. 5 shows the container-receiving space 45 before it is occupied by a storage container 9 and FIG. 6 shows the container-receiving space 45 after it has been occupied by a storage container 9. The container-receiving space 45 is sized such that enough of a storage container 9 can fit inside the space 45 to enable the bot 25 to move across the track structure 13 on top of storage structure 1 without the underside of the storage container 9 catching on the track structure 13 or another part of the storage structure 1. When the bot 25 has reached its intended destination, the lifting assembly 33 controls the tethers 35 to lower the container-holding assembly 37 and the corresponding storage container 9 out of the space 45 and into the intended position. The intended position may be a stack 11 of storage containers 9 or an egress point of the storage structure 1 (or an ingress point of the storage structure 1 if the bot 25 has moved to collect a storage container 9 for storage in the storage structure 1). Although in the illustrated example the upper and lower portions 41, 43 are separated by a physical divider, in other examples, the upper and lower portions 41, 43 may not be physically divided by a specific component or part of the external body 27 of the bot 25. The upper and lower configuration of the bot 25 allows the bot 25 to occupy only a single grid cell 14 on the track structure 13 of the storage system 1.

In an alternative example, the container-receiving space 45 of the bot 25 may not be within the external body 27 of the bot 25. For example, the container-receiving space 49 may instead be adjacent to the external body 27 of the bot 25, e.g. in a cantilever arrangement with the weight of the external body 27 of the bot 25 counterbalancing the weight of the container 9 to be lifted. In such embodiments, a frame or arms of the lifting assembly 33 may protrude horizontally from the external body 27 of the bot 25, and the tethers 35 may be arranged at respective locations on the protruding frame/arms and configured to be raised and lowered from those locations to raise and lower a storage container 9 into the container-receiving space 45 adjacent to the external body 27.

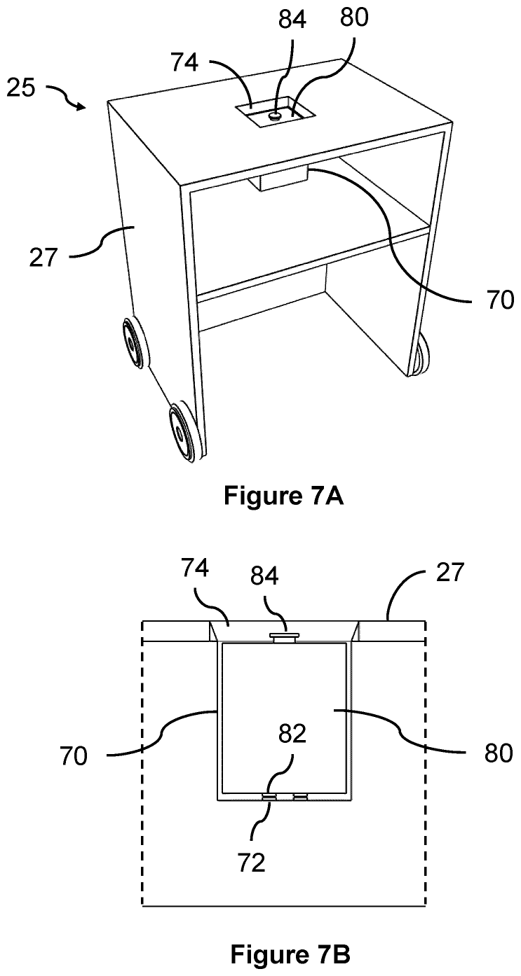

FIG. 7A shows a similar view of the bot 25 to FIGS. 5 and 6 but shows a rechargeable battery 80 received within a battery compartment 70 of the bot 25. The lifting assembly 33 and the container-holding assembly 37 have been omitted from view for clarity.

The battery 80 provides electrical power to one or more components of the bot 100, such as the lifting assembly 33, the container-holding assembly 37, and the driving assembly. The battery 80 may be of any suitable rechargeable battery chemistry such as lithium-ion, lithium iron phosphate, nickel metal hydride, nickel-cadmium, etc. The battery 80 comprises an outer casing which houses the cells of the battery 80. To facilitate handling of the battery 80, the outer casing 204 comprises one or more engagement features 84 for being engaged by the end effector of a robotic arm to allow the robotic arm to move the battery 80 into and out of the battery compartment 70. The engagement feature 84 may be a simple protruding feature such as a handle that can be gripped by an end effector comprising a gripping assembly, or may be part of a more complex battery retention mechanism for releasably locking the battery 80 in the battery compartment 70. Examples of such battery retention mechanisms are described in United Kingdom patent application nos. GB2211853.3, GB2207553.5, and GB2216843.9, each of which is incorporated herein by reference.

The battery compartment 70 is externally exposed at the top of the bot 25 such that the battery 80 can be received in a downwards direction from a location above the external body 27 of the bot 25. In this illustrated example, the battery compartment 70 is located within the external body 27 of the bot 25 and comprises an opening in a top surface of the external body 27 to allow the battery 80 to be moved into and out of the battery compartment 70. In alternative examples, the battery compartment may be located partially within the external body 27 of the bot 25 (i.e. the battery compartment extends past the top surface of the external body 27) or located outside the external body 27 of the bot 25 (e.g. on top of the top surface of the external body 27 of the bot 25).

FIG. 7B shows a schematic cross-section view of the battery 80 within the battery compartment 70. The battery 80 comprises one or more electrical connectors 82 and the battery compartment 70 comprises one or more corresponding electrical connectors 72 which are electrically coupled (directly or indirectly) to the components of the bot 25 that are to be powered by the battery 80. The electrical connectors 82, 72 are configured to electrically couple to each other when the battery 80 is inserted into the battery compartment 70. The electrical connectors 82, 72 can be any suitable electrical connector for delivering power once connected. The electrical connectors 82, 72 may be blind mate connectors, which physically connect via the action of moving the battery 80 into the battery compartment 70.

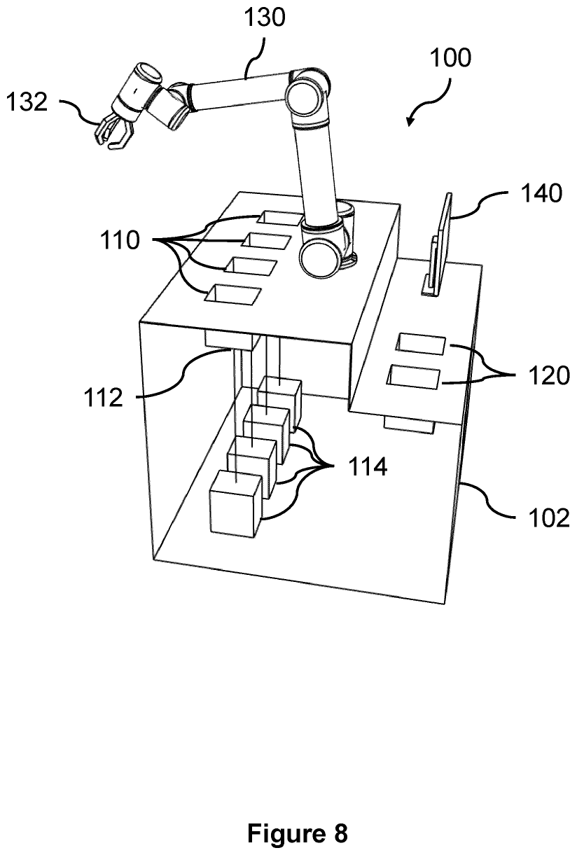

FIG. 8 shows a battery exchange station 100 at which batteries 80 can be charged and exchanged with batteries 80 in the bots 25. The battery exchange station 100 comprises a charging system for charging a battery 80. The charging system comprises one or more charging bays 110 and one or more battery chargers 114 connected to a power supply. Each charging bay comprises an electrical connector 112 electrically coupled to a corresponding battery charger 114. The electrical connector 112 of each charging bay 110 is configured to connect to the electrical connector 82 of the battery 80 when the battery 80 is inserted into the charging bay 110 (much like the electrical connector 72 of the battery compartment 70). Once the electrical connector 82 of a battery 80 and the electrical connector 112 of a charging bay 110 are connected, the battery charger 114 can deliver current to the battery 80 to recharge its cells. The battery 80 preferably comprises a battery management system (BMS) to protect against hazards such as over-current, over-voltage and over-temperature during charging. Each charging bay 110 may further comprise a sensor (e.g. a light gate) for detecting when the charging bay 110 is occupied by a battery 80, or the charging system may infer that a charging bay 110 is occupied if current is being drawn from its associated battery charger. The sensor for detecting the presence of a battery in a bay may be a load cell to detect the weight of a battery in the bay.

The battery exchange station 100 further comprises a cabinet 102 which houses at least some of the components of the charging system (e.g. the battery chargers 114) and at which the charging bays 110 are located. Each charging bay 110 is in the form of a receptacle with an opening in a top surface of the cabinet 102 to allow a battery 80 to be received into the receptacle in a vertical direction. The cabinet 102 preferably comprises a door to allow convenient access to the components of the charging system housed within the cabinet 102.

The cabinet 102 further comprises at least one buffer bay 120. Each buffer bay 120 is also in the form of a receptacle with an opening in the top surface 104 of the cabinet 102 to allow a battery 80 to be received into the receptacle in a vertical direction. In contrast to the charging bays 110, none of the buffer bays 112 are charging bays 110 and they are not part of the charging system. In particular, none of the buffer bays 112 are electrically coupled to the battery chargers 114 and are therefore not capable of charging a battery 80. Buffer bays may also be referred to as non-charging buffer bays. In some examples, none of the buffer bays 120 have an electrical connector for connecting to the electrical connector 82 of the battery 80 when the battery 80 is received in the buffer bay 120.

Each buffer bay 120 comprises coupling means configured to establish communication with the BMS of a battery received in the buffer bay. For example, the coupling means could be an electrical connector (not electrically coupled to the charging system) which is configured to connect to the electrical connector 112 of the battery 80 to establish communication with the battery's BMS for monitoring purposes, e.g. to monitor the temperature of the battery 80.

In some examples, each buffer bay 120 may comprise one or more sensors, e.g. to sense the presence of a battery 80 in the buffer bay 120. Each buffer bay 120, like the charging bays, may further comprise a sensor (e.g. a light gate) for detecting when the buffer bay 120 is occupied by a battery 80. The sensor for detecting the presence of a battery in a buffer bay may be a load cell to detect the weight of a battery in the bay. Alternatively, the connection to the BMS may be used to infer that a battery is present or absent.

Temperature monitoring of a battery in a buffer bay is a safety feature. If the battery overheats, for example if the measured temperature exceeds a predetermined threshold temperature, appropriate action can be taken. For example the battery exchange station can raise an error, switch off the power supply, and/or activate fire safety feature such as sprinklers. A switch can be activated to disconnect the battery chargers from the charging bays.

In particular, a system with a means of monitoring temperature in the buffer bays as well as in the charging bays has the advantage of ensuring that the temperature of the battery is always monitored, irrespective of where the battery is located in the battery exchange station.

In some examples the battery may be provided with two types of temperature sensors: one or more first-type temperature sensors send temperature data to the BMS; and one or more second-type temperature sensors are electrically connected to the electrical connector of the battery, rather than being connected through the BMS. As well as providing a useful cross-check of the data from the first-type temperature sensors, the second-type temperature sensors are independent of the BMS so will still operate in the case of a software failure. In some examples, if the temperature reading(s) from the one or more second-type temperature sensors are outside of a predetermined acceptable temperature range, the charger will not provide charge to the battery. The second-type temperature sensors are effectively a hardware failsafe mechanism; if there is a software problem the second-type temperature sensors will still operate and be accessible directly through the electrical connector of the battery.

Another advantage of the buffer bays having a connection to the battery's BMS is that the battery state of charge (SOC) can be determined from the BMS. If a battery is in a buffer bay, and the SOC of the battery is below a predetermined threshold level, the robot arm can be instructed to move the battery from the buffer bay to a charging bay. This enables batteries stored in the buffer bays to be “topped up”. Even if fully charged, a battery will gradually discharge over time, so leaving a battery in a buffer bay over a long period of time would result in the battery discharging. Knowing the SOC of a battery in the buffer bay enables the battery to be moved to a charging bay to be charged when necessary. A battery in the buffer bay can also be monitored to determine whether it is ready to be deployed in a battery-powered device.

The battery exchange station 100 further comprises a robotic arm 130 for moving batteries 80 between a load handling device 25 and the battery exchange station 100. In the illustrated example, the robotic arm 130 is mounted on the cabinet 102 but could alternatively be mounted adjacent to the cabinet 102. The robotic arm 130 comprises an end effector 132 suitable for selectively engaging and releasing the engagement feature 84 of the battery 80 to allow the robotic arm 130 to pick up and place the battery 80 at different locations. The robotic arm 130 has enough degrees of freedom to allow the robotic arm 130 to move a battery 80 between a battery compartment 70 of a bot 25, a charging bay 110 and a buffer bay 120. The illustrated robotic arm 130 is in the form of an articulated robot comprising joints and linkages to provide the desired degrees of freedom (e.g. six degrees of freedom), but the robotic arm 130 could also take other forms such as a gantry robot that can move the end effector 132 in two or three perpendicular directions (i.e. two or three degrees of freedom).

During operation of the bot 25 on the track structure 13, the energy in the battery 80 will continuously deplete until the depleted battery 80 needs to be exchanged for a replacement battery 80 to allow the bot 100 to continue operation on the track structure 13.

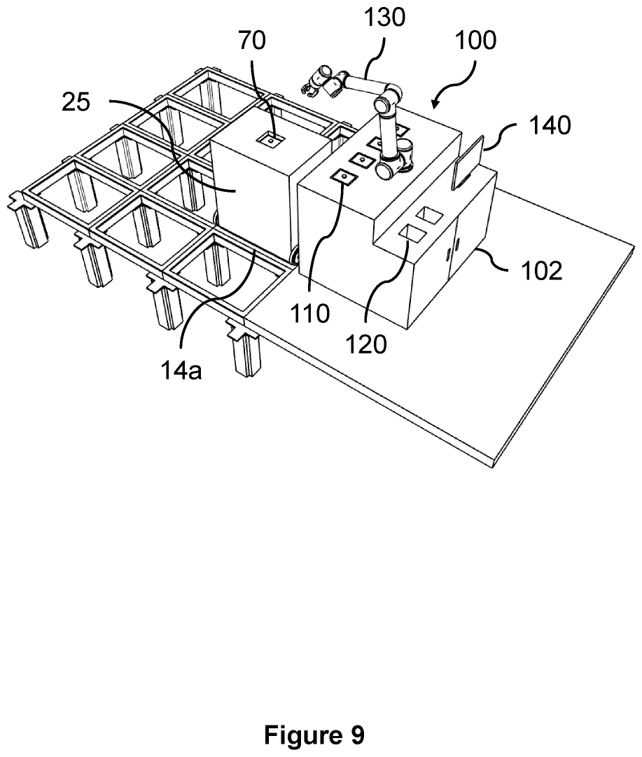

FIG. 9 shows the battery exchange station 100 located next to the track structure 13. For example, the battery exchange station 100 could be located on a mezzanine floor at the same height as the track structure 13. The track structure 13 has one or more designated grid cells 14a at which the bot 25 is required to move to in order for a battery exchange to take place. The designated grid cells 14a are the grid cells 14 located next to the battery exchange station 100 that are accessible to the end effector 132 of the robotic arm 130. The battery exchange station 100 may have more than one designated grid cell 14a in its vicinity depending on the reach of the robotic arm 130. Once the bot 25 has moved to a designated grid cell 14a, the battery compartment 70 may be at a predetermined position with respect to the robotic arm 130 such that the robotic arm 130 can perform a set of predetermined movements of the end effector to engage and move the battery 80 to perform a battery exchange. Thus, the battery 80, the battery compartment 70, and the battery exchange station 100 form part of a battery exchange system in which a battery 80 in a bot 25 can be exchanged with a battery 80 in a charging bay 110 in an automated manner while the bot 25 remains on the track structure 13. In alternative examples, the battery exchange station 100 may be located on the track structure 13 itself, rather than next to the track structure 13.

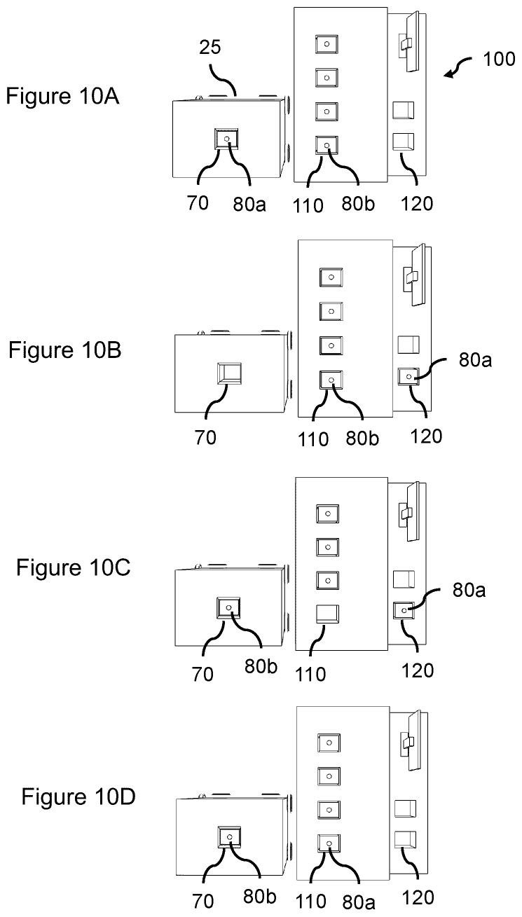

To exchange a depleted battery 80 in the bot 25 with a charged battery 80 in a charging bay 110 of the battery exchange station 100, the robotic arm 130 can perform the following first example method, as represented by FIGS. 10A-10D which show the bot 25 and the battery exchange station 100 from above. The robotic arm 130 has been omitted for clarity.

In FIG. 10A, a bot 25 with a depleted battery 80a in its battery compartment 70 has arrived at a designated grid cell 14a next to the battery exchange station 100. Each of the charging bays 110 is occupied by a charged or charging battery 80. The buffer bays 120 are unoccupied.

In FIG. 10B, the robotic arm 130 has engaged and removed the depleted battery 80a from the bot 25 and has then placed and released the depleted battery 80a in one of the buffer bays 120.

In FIG. 10C, the robotic arm 130 has engaged and removed a charged battery 80b from one of the charging bays 110 and has then placed and released the charged battery 80b in the battery compartment 70 of the bot 25 so that the bot 25 can move away from the designated grid cell 14a and continue normal operation on the storage structure 1 using power from the charged battery 80b.

In FIG. 10D, the robotic arm 130 has engaged and removed the depleted battery 80 from the buffer bay 120 and has then placed and released the depleted battery 80a in the vacated charging bay 110 (i.e. the charging bay 120 from which the charged battery 80b was just removed) so that the depleted battery 80a can begin recharging.

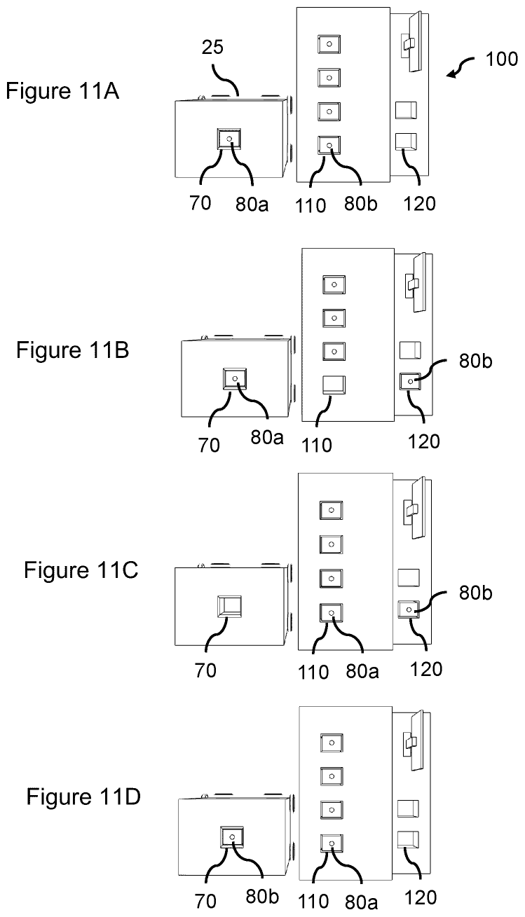

The robotic arm 130 could also perform a second, alternative method, as represented by FIGS. 11A-11D.

In FIG. 11A, a bot 25 with a depleted battery 80a in its battery compartment 70 has arrived at a designated grid cell 14a next to the battery exchange station 100. Each of the charging bays 110 is occupied by a charged or charging battery 80. The buffer bays 120 are unoccupied.

In FIG. 11B, the robotic arm 130 has engaged and removed a charged battery 80b from a charging bay 110 and has then placed and released the charged battery 80b in one of the buffer bays 120.

In FIG. 11C, the robotic arm 130 has engaged and removed the depleted battery 80a from the bot 25 and has then placed and released the depleted battery 80a in the vacated charging bay 110 so that the depleted battery 80a can begin recharging.

In FIG. 11D, the robotic arm 130 has engaged and removed the charged battery 80b from the buffer bay 120 and has then placed and released the charged battery 80b in the battery compartment 70 of the bot 25 so that the bot 25 can move away from the designated grid cell 14a and continue normal operation on the storage structure 1 using power from the charged battery 80b.

It can be seen that in each method, the buffer bay 120 acts as an intermediate/temporary holding region for placing a battery 80 during the battery exchange, in particular when moving a battery 80 from the bot 25 to the charging bay 110, or when moving a battery 80 from a charging bay 110 to the bot 25, depending on which of the above two methods is being carried out.

In either method, the state of charge of the depleted battery 80a does not need to be 0% or almost 0% at the time of the exchange, but could just be equal to or lower than a predetermined threshold, e.g. 10% or lower. Similarly, the state of charge of the charged battery 80b at the time of the exchange does not need to be 100% but could just be equal to or higher than a predetermined threshold, e.g. 80% or higher, or at least higher than the state of charge of the depleted battery 80a. Furthermore, the charged battery 80b does not need to have stopped charging at the time of the exchange and could instead still be in a state of charging.

The first method and the second method are similar in effect, but in the first method, the time that the charged battery 80b spends in the charging bay 110 can be maximised and therefore the charged battery 80b can have a higher state of charge when it is placed into the bot 25, which allows the bot 25 to run for longer before needing to return to the battery exchange station 100. On the other hand, in the second method, the time that the bot 25 needs to spend at the battery exchange station 100 can be minimised, particularly if the charged battery 80b is moved to the buffer bay 120 in anticipation of the bot 25 arriving at the battery exchange station 100 (i.e. just before the bot 25 arrives at the battery exchange station).

It can be seen that the minimum number of charging bays 110 and buffer bays 120 that the battery exchange station 100 requires in order to carry out the above methods is one of each. However, providing a plurality of charging bays 110 provides redundancy and increases the likelihood that there will be a battery 80 with a high state of charge in one of the charging bays 110 for putting into a bot 25. Providing a plurality of buffer bays 120 also provides redundancy in case there is a problem with one of the buffer bays 120 or a battery 80 in one of the buffer bays 120.

By using a buffer bay 120 as an intermediate/temporary holding region during each battery exchange operation, it can be seen that a charging bay 110 only needs to be vacated at the point at which a battery exchange operation is taking place. Without the presence of a buffer bay 120, the battery exchange station 100 would need to keep at least one charging bay 110 unoccupied at all times in anticipation of a future battery exchange operation in order to provide a place for the depleted battery 80a to be moved into before a charged battery 80b can be moved into the bot 25. Therefore, the battery exchange station 100 allows all of the charging bays 110 to be occupied by batteries 80 for a majority of the time to maximise the use of every charging bay 110. This is particularly advantageous because each charging bay 110 is relatively expensive and therefore keeping a charging bay 110 empty at all times would be an inefficient use of capital. An alternative solution to providing buffer bays 120 could be to provide the battery exchange station 100 with two robotic arms 140 configured to exchange a depleted battery 80a in a bot 25 with a charged battery in a charging bay 110 substantially simultaneously. However, the capital cost of a robotic arm 130 is high and therefore the battery exchange station 100, which only requires the use of a single robotic arm 140 and a relatively inexpensive buffer bay 120, provides a cost-effective way of maximising the use of the charging bays 110.

The battery exchange station 100 can also be configured to allow a human worker to manually initiate the robotic arm 130 to move a battery 80 from a buffer bay 120 to a charging bay 110 and/or vice versa. In particular, the battery exchange station 100 can comprise a computer terminal 140 communicably coupled to the robotic arm 130 and configured to send commands to the robotic arm 130 to command it to move a battery 80 from a particular buffer bay 120 to a charging bay 130 and/or vice versa. If a worker wishes to place a battery 80 into a charging bay 110, the worker can first put the battery 80 in a buffer bay 120 and then command the robotic arm 130 via the computer terminal 140 to move the battery 80 from the buffer bay 120 to a charging bay 110. If a worker wishes to retrieve a battery 80 from a charging bay 110, the worker can command the robotic arm 130 via the computer terminal 140 to move the battery 80 from a particular charging bay 110 to a buffer bay 110 from where the worker can retrieve it. This may be useful, for example, if the height of the charging bays 110 above the floor is too high to allow the charging bays 110 to be accessed by a human worker comfortably. In this case, the buffer bays 120 can be located lower than the charging bays 110, at a height more comfortable for a human worker to access, as shown in FIG. 9.

The storage and retrieval system may further comprise a central control system comprising one or more controllers configured to command the bots 25 to move to particular grid cells 14 on the track structure 13 and command the robotic arm 130 to perform the above-described methods of exchanging the battery 80. Each bot 25 may comprise a local bot controller configured to receive and carry out commands from the central control system, e.g. by controlling the driving assembly to move to a particular grid cell 14. The robotic arm 130 may comprise a local arm controller configured to receive and carry out commands from the central control system, e.g. by controlling the robotic arm 130 to perform predetermined movements to move a battery 80 between the bot 25, a particular charging bay 110 and a particular buffer bay 120 as required. The battery exchange station may comprise a separate control system, or be controlled by the central control system.

The central control system may communicate wirelessly with the bots 25 and the robotic arms 130 via wireless transmitters and receivers using known wireless communication technologies such as 4G, 5G, Wi-Fi, etc.

When the battery 80 in a bot 25 has depleted past a threshold state of charge (as indicated by the BMS), the bot controller can report this to the central control system which can then command the bot 25 to move to a designated grid cell 14a for performing a battery exchange.

The central control system is configured to keep track of which charging bays 110 are occupied by a battery 80 (or determine occupancy directly via sensors, for example) and keep track of the state of charge of each battery 80 (e.g. via each battery's BMS) to determine which particular battery 80 in the charging bays 110 should be exchanged with the depleted battery 80 in the bot 25. For example, the central control system may be configured to command the robotic arm 130 to exchange a depleted battery 80 in a bot 25 with the charged battery 80 that has the highest state of charge in the charging bays 110.

The above-described control system is only one example of how the control system of the storage and retrieval system could be set up and other ways of distributing control of the bots 25 and the robotic arm 130 will be apparent to the skilled person.

The battery exchange station is not limited to the precise forms described above and various modifications and variations falling within the scope of the claims will be apparent to the skilled person.

For example, although each buffer bay 120 described above is in the form of a receptacle for receiving a battery 80, each buffer bay 120 could take any form that is suitable for allowing a battery 80 to be temporarily placed in a particular location. For example, each buffer bay 120 could simply be a particular region on a flat surface on which the battery 80 is placed. However, a receptacle is useful for holding the battery 80 securely while it is in the buffer bay 120.

In addition, the buffer bays 120 do not necessarily need to be provided on the same support structure (i.e. cabinet 102) as the charging bays 110 and could instead be provided on a separate support structure adjacent to the cabinet 102.

Although the above-described system is a system in which batteries 80 are received in the bot 25 and the battery exchange station 100 in a downwards direction, the above-described methods of exchanging a battery 80 are not limited to inserting and removing batteries 80 in a vertical direction and are applicable to systems in which batteries 80 are inserted and removed in other directions, e.g. horizontally.

Furthermore, the above-described methods of exchanging a battery 80 are not just applicable to the above-described storage and retrieval system, but are generally applicable to any system in which rechargeable batteries or other electric power sources are exchanged between a battery powered device (e.g. an electric vehicle) and an exchange station at which the batteries are being charged.

The disclosure may also be defined by the following clauses:
A. A method of exchanging a first rechargeable battery with a second rechargeable battery, wherein the first rechargeable battery is located in a battery-powered device and the second rechargeable battery is located in a charging bay configured to charge a battery, the method comprising the steps of:
   (i) removing the first rechargeable battery from the device and placing it in a buffer bay;
   (ii) removing the second rechargeable battery from the charging bay and placing it in the device; and
   (iii) removing the first rechargeable battery from the buffer bay and placing it in the charging bay.
B. A method of exchanging a first rechargeable battery with a second rechargeable battery, wherein the first rechargeable battery is located in a battery-powered device and the second rechargeable battery is located in a charging bay configured to charge a battery, the method comprising the steps of:
   (i) removing the second rechargeable battery from the charging bay and placing it in a buffer bay;
   (ii) removing the first rechargeable battery from the device and placing it in the charging bay; and
   (iii) removing the second rechargeable battery from the buffer bay and placing it in the device.
C. The method according to clause A or clause B, wherein steps (i)-(iii) are carried out by a robotic arm.
D. The method according to clause C, wherein steps (i)-(iii) are carried out by the same robotic arm.
E. A battery exchange station comprising:
   one or more charging bays configured to receive and charge a battery;
   one or more buffer bays; and
   a robotic arm configured to exchange a first rechargeable battery located in a device with a second battery located in one of the charging bays by performing the method of any one of clauses A to D.
F. The battery exchange station according to clause E, wherein each charging bay comprises an electrical connector for connecting to a battery received in the charging bay, and wherein the battery exchange station further comprises one or more battery chargers, each electrical connector being electrically coupled to a respective battery charger.
G. The battery exchange station according to clause E or clause F, wherein each buffer bay is not configured to charge a battery received in the buffer bay.
H. The battery exchange station according to any one of clauses E to G, wherein the one or more buffer bays are lower than the one or more charging bays.
I. A storage and retrieval system comprising:
   a storage structure, the storage structure comprising:
      a plurality of horizontal members arranged to form a grid pattern defining a plurality of grid cells;
      a plurality of upright members configured to support the horizontal members from below to define a storage area below the grid cells for storing stacks of storage containers;
      a track structure located on top of the horizontal members, wherein the track structure comprises a plurality of tracks arranged to form a grid pattern corresponding to the grid pattern formed by the horizontal members; and
   one or more load handling devices, each load handling device comprising:
      a driving assembly configured to move the load handling device on the track structure;
      a container-holding assembly configured to releasably hold a storage container from above; and
      a lifting assembly configured to raise and lower the container-holding assembly to allow the load handling device to lift and lower storage containers into and out of the storage structure and the passage via the grid cells;
   one or more battery exchange stations according to any one of clauses E to H, wherein each battery exchange station is located next to or on the track structure.

1. A battery exchange station for charging a plurality of batteries, the battery exchange station comprising:
i) a cabinet comprising a plurality of battery chargers;
ii) a plurality of bays each configured to receive a battery, the plurality of bays being grouped into:
a) a first sub-group of bays, the first sub-group comprising a plurality of charging bays, each of the plurality of charging bays comprising an electrical connector for connecting to the battery received in the charging bay, each electrical connector being electrically coupled to a respective one of the plurality of battery chargers;
b) a second sub-group of bays, the second sub-group comprising one or more non-charging buffer bays, each of the one or more non-charging buffer bays comprising one or more sensors to detect the presence of a battery in the bay; and
iii) a robotic arm configured to exchange a battery located in a battery-powered device with a battery located in one of the plurality of charging bays.

2. The battery exchange station of claim 1, wherein the cabinet is a single body.

3. The battery exchange station of claim 1, wherein the plurality of bays are housed in the cabinet.

4. The battery exchange station of claim 3, wherein each of the plurality of bays is in the form of a receptacle with an opening in a top surface of the cabinet to allow a battery (80) to be received into the receptacle in a vertical direction.

5. The battery exchange station of claim 4, wherein the cabinet comprises a first top surface and a second top surface, and the respective opening of each of the plurality of charging bays in the first sub-group is in the first top surface, and the respective opening of each of the one or more non-charging buffer bays in the second sub-group is in the second top surface.

6. The battery exchange station of claim 5, wherein the second top surface of the cabinet is at a lower vertical level than first top surface of the cabinet.

7. The battery exchange station of claim 1, wherein the ratio of the number of charging bays in the first sub-group to the number of non-charging buffer bays in the second sub-group is between 2:1 and 10:1.

8. The battery exchange station of claim 7, wherein the ratio of the number of charging bays in the first sub-group to the number of non-charging buffer bays in the second sub-group is 4:1.

9. The battery exchange station of claim 1, wherein one or more of the plurality of bays comprises a visual indicator of the state of charge of a battery received within the bay.

10. The battery exchange station of claim 1, further comprising a control system configured to:
i) determine the state of charge of a battery received within one of the plurality of non-charging buffer bays; and
ii) instruct the robotic arm to move the battery from the non-charging buffer bay to one of the plurality of charging bays if the state of charge of the battery is below a predetermined threshold charge level.

11. The battery exchange station of claim 10, wherein the control system is further configured to:
i) determine whether the temperature of a battery in any of the plurality of bays exceeds a predetermined temperature threshold and/or whether the current of a battery in any of the plurality of bays exceeds a predetermined current; and
ii) activate a switch to disconnect the plurality of battery chargers from the plurality of charging bays if the temperature of the battery exceeds a predetermined temperature threshold and/or the current of the battery exceeds a predetermined current.

12. A storage and retrieval system comprising:
one or more battery exchange stations according to claim 1;
a storage structure, the storage structure comprising:
a plurality of horizontal members arranged to form a grid pattern defining a plurality of grid cells;
a plurality of upright members configured to support the horizontal members from below to define a storage area below the grid cells for storing stacks of storage containers;
a track structure located on top of the horizontal members, wherein the track structure comprises a plurality of tracks arranged to form a grid pattern corresponding to the grid pattern formed by the horizontal members; and
one or more load handling devices, each load handling device comprising:
a driving assembly configured to move the load handling device on the track structure;
a container-holding assembly configured to releasably hold a storage container from above; and
a lifting assembly configured to raise and lower the container-holding assembly to allow the load handling device to lift and lower storage containers into and out of the storage structure and the passage via the grid cells;
wherein each battery exchange station is located next to or on the track structure.

13. A method of exchanging a first battery with a second battery at a battery exchange station as defined in claim 1, wherein the first battery is located in a battery-powered device and the second battery is located in a charging bay, the method comprising the steps of:
(i) removing the first battery from the battery-powered device and placing it in a non-charging buffer bay;
(ii) removing the second battery from the charging bay and placing it in the battery-powered device; and
(iii) removing the first battery from the non-charging buffer bay and placing it in the charging bay.

14. A method of exchanging a first battery with a second battery at a battery exchange station as defined in claim 1, wherein the first battery is located in a battery-powered device and the second battery is located in a charging bay, the method comprising the steps of:
(i) removing the second battery from the charging bay and placing it in a non-charging buffer bay;
(ii) removing the first battery from the battery-powered device and placing it in the charging bay; and
(iii) removing the second battery from the non-charging buffer bay and placing it in the battery-powered device.

15. The method of claim 13, wherein steps (i)-(iii) are carried out by a robotic arm.

16. The method of claim 15, wherein all of the steps (i)-(iii) are carried out by the same robotic arm.

17. The method of claim 14, wherein steps (i)-(iii) are carried out by a robotic arm.

18. The method of claim 17, wherein all of the steps (i)-(iii) are carried out by the same robotic arm.

19. The battery exchange station of claim 1, wherein each of the batteries comprises a battery management system (BMS), and each of the one or more non-charging buffer bays comprises coupling means configured to establish communication with the BMS of the battery received in the non-charging buffer bay.
